(19) United States
(12) Patent Application Publication
(10) Pub. No.: US 2025/0001692 A1
(43) Pub. Date: Jan. 2, 2025

(54) ON-THE-FLY 3D PRINTING

(71) Applicant: 3D Sil Ltd., Rosh Haayin (IL)

(72) Inventors: Roi Ramot, Rosh Haayin (IL); Yair Ramot, Maas (IL)

(73) Assignee: 3D Sil Ltd., Rosh Haayin (IL)

(21) Appl. No.: 18/709,505

(22) PCT Filed: Nov. 9, 2022
(86) PCT No.: PCT/IB2022/060783

§ 371 Date: May 12, 2024

Related U.S. Application Data
(60) Provisional application No. 63/279,121, filed on Nov. 14, 2021.
(60) Provisional application No. 63/340,479, filed on May 11, 2022.

(51) Int. Cl. B29C 64/364; B29C 33/38; B29C 33/40; B29C 64/118; B29C 64/209; B29C 64/241; B29C 64/245; B29C 64/25; B29C 64/255; B29C 64/35; B29C 64/40; B29K 83/00; B29L 31/00; B33Y 10/00; B33Y 30/00; B33Y 40/20; B33Y 80/00

(52) U.S. Cl. CPC B29C 64/364; B29C 33/3842; B29C 33/40; B29C 64/118; B29C 64/209; B29C 64/241; B29C 64/245; B29C 64/25; B29C 64/255; B29C 64/35; B29C 64/40; B33Y 10/00; B33Y 30/00; B33Y 40/20; B33Y 80/00; B29K 2083/005; B29L 2031/7532

(57) ABSTRACT

A vacuum sealed 3D printer (10), comprising: at least one vacuum chamber (3) defining at least one operational area, said at least one vacuum chamber sealingly sized and shaped to enclose: (i) at least one build plate (1), movable along at least one axis; and, (ii) at least one printing head (100), movable along at least one axis, comprising at least one printing nozzle (10) for depositing at least one curable polymer on said at least one build plate (1) for the formation of at least one 3D object: at least one vacuum pump (7), in fluid tight communication with said at least one vacuum chamber (3), such that when said vacuum pump (7) is activated vacuum is applied within said vacuum chamber (3) to remove air bubbles created during depositing said at least one curable polymer.

### FIELD OF THE INVENTION

The present invention relates to a method of fabricating heat-curable polymer objects, such as implants.

### BACKGROUND OF THE INVENTION

Medical implants that are customized to a specific patient and address a clinical need have become a reality in recent years, and a customized implant is a vastly superior clinical solution for many patients.

Silicone rubber is highly suitable for use in medical implants due to a lack of reactivity with the human body and the fact that it is easily molded into any desired shape and holds its shape for extended periods of time.

Silicone implants are made from medical grade silicone (FDA/CE approved, e.g., NUSIL) with varying properties (e.g., Shore hardness levels) and are typically manufactured using high volume methods, such as injection molding, compression molding or rotary molding. These approaches require the design and manufacturing of a dedicated mold and the certification of the molding process for every product. This is a lengthy and costly process, and as such, it is not well suited for customized implants.

Customized silicone implants are typically fabricated by manually carving silicone blocks; fabrication is typically carried out by the surgeon using a knife. This approach is relatively inexpensive but highly inaccurate and surgeon-specific and as such, surgical outcomes of surgeries that utilize carved block implants vary in quality.

There is thus a need for, and it would be highly advantageous to have, an inexpensive and relatively fast approach for fabricating highly accurate and personalized silicone implants.

### SUMMARY OF THE INVENTION

It is one object of the present invention to provide a vacuum sealed 3D printer, comprising:
at least one vacuum chamber defining at least one operational area, said at least one vacuum chamber sealingly sized and shaped to enclose:
   (i) at least one build plate; and,
   (ii) at least one printing head, comprising at least one printing nozzle for depositing at least one curable polymer on said at least one build plate for the formation of at least one 3D object;
at least one vacuum pump, in fluid tight communication with said at least one vacuum chamber, such that when said vacuum pump is activated vacuum is applied within said vacuum chamber.

It is another object of the present invention to provide the vacuum 3D printer as defined above, wherein said at least one vacuum chamber comprising at least one door, hingedly connected to said at least one vacuum chamber.

It is another object of the present invention to provide the vacuum 3D printer as defined above, comprising at least one sealing member disposed along the perimeter of said at least one vacuum chamber.

It is another object of the present invention to provide the vacuum 3D printer as defined above, wherein, when said at least one door is closed, said at least one vacuum chamber is fluid tight sealed.

It is another object of the present invention to provide the 3D printer as defined above, wherein said at least one curable polymer is extruded out of said at least one printing nozzle.

It is another object of the present invention to provide the 3D printer as defined above, wherein said at least two curable polymers are extruded out of said at least one printing nozzle.

It is another object of the present invention to provide the 3D printer as defined above, wherein said at least two curable polymers are extruded at either a substantially constant ratio of amounts one relative to the other or at a varying ratio of amounts one relative to the other.

It is another object of the present invention to provide the 3D printer as defined above, wherein, when said at least one vacuum pump is inactive, no vacuum is applied within said at least one vacuum chamber; and, said at least one curable polymer is prevented from being extruded from said at least one printing nozzle to form said at least one 3D object.

It is another object of the present invention to provide the 3D printer as defined above, wherein, when said at least one vacuum pump is active, vacuum is applied within said at least one vacuum chamber; and, said at least one curable polymer is being extruded from said at least one printing nozzle.

It is another object of the present invention to provide the 3D printer as defined above, wherein said at least one curable polymer is contained within at least one container.

It is another object of the present invention to provide the 3D printer as defined above, wherein said at least one container comprises at least one valve adapted, when open, to facilitate extraction of said curable polymer therefrom; and when closed, to prevent extraction of said curable polymer therefrom.

It is another object of the present invention to provide the 3D printer as defined above, wherein when said at least one vacuum pump is active, vacuum is applied within said at least one vacuum chamber, said valve is open to facilitate entrance of air into said at least one container and extraction of said curable polymer therefrom is facilitated.

It is another object of the present invention to provide the 3D printer as defined above, wherein when said at least one vacuum pump is inactive, said valve is closed to prevent entrance of air into said at least one container and extraction of said curable polymer therefrom.

It is another object of the present invention to provide the 3D printer as defined above, wherein said applied vacuum facilitate in the removal of any trapped air bubbles in the extruded curable polymer.

It is another object of the present invention to provide the 3D printer as defined above, additionally comprising at least one vibration actuator arranged for providing a vibrating motion to said at least one build plate in a direction selected from a group consisting of x, y, z and any combination thereof.

It is another object of the present invention to provide the 3D printer as defined above, wherein said vibration actuator is an ultrasound transducer or any motoric means capable of applying vibrations.

It is another object of the present invention to provide the 3D printer as defined above, wherein said vibration facilitates in the removal of any trapped air bubbles in the extruded curable polymer.

It is another object of the present invention to provide the 3D printer as defined above, additionally comprising at least one vibration actuator arranged for providing a vibrating motion to said at least one printing head and/or said at least one printing nozzle, in a direction selected from a group consisting of x, y, z and any combination thereof.

It is another object of the present invention to provide the 3D printer as defined above, wherein said vibration actuator is an ultrasound transducer or any motoric means capable of applying vibrations.

It is another object of the present invention to provide the 3D printer as defined above, wherein said vibration facilitates in the removal of any trapped air bubbles in the extruded curable polymer.

It is another object of the present invention to provide the 3D printer as defined above, wherein said at least one printing head and said at least one build plate are arranged to be translated relative to each other.

It is another object of the present invention to provide the 3D printer as defined above, wherein said at least one curable polymer is provided in the form selected from a group consisting of powders, liquids, gel and any combination thereof.

It is another object of the present invention to provide the 3D printer as defined above, wherein each printing nozzle is in communication with at least one feeding line.

It is another object of the present invention to provide the 3D printer as defined above, wherein each printing nozzle is in communication with a plurality of feeding lines.

It is another object of the present invention to provide the 3D printer as defined above, wherein each feeding line is adapted to provide different types of curable polymers to said printing nozzle.

It is another object of the present invention to provide the 3D printer as defined above, wherein each printing nozzle additionally comprising at least one mixer, adapted to mix different types of curable polymers before being extruded from said printing nozzle.

It is another object of the present invention to provide the 3D printer as defined above, wherein said at least one printing head is shaped as a revolving plate.

It is another object of the present invention to provide the 3D printer as defined above, wherein said printing head comprises at least one opening, such that once said at least one printing nozzle is aligned with said at least one opening, only said at least one curable polymer is extruded from said at least one printing nozzle.

It is another object of the present invention to provide the 3D printer as defined above, wherein said at least one printing head is in electrical communication with at least one stepper motor or servo motor, adapted to rotate said at least one printing head such that upon each move, one of said at least one of said printing nozzle is aligned with said opening to facilitate extruding of said at least one curable polymer.

It is another object of the present invention to provide the 3D printer as defined above, additionally comprising a processor, said processor controlling the position of said at least one printing head and said at least one printing nozzle over said operational area during the formation of said 3D object.

It is another object of the present invention to provide the 3D printer as defined above, wherein said processor is adapted to control at least one of said printing nozzles and the flow of said at least one curable polymer therethrough.

It is another object of the present invention to provide the 3D printer as defined above, wherein at least one selected from a group consisting of said at least one printing head, said at least one printing nozzle is a single used.

It is another object of the present invention to provide the 3D printer as defined above, wherein said at least one printing head comprising at least one cleaning element adapted to wipe clean said at least one printing nozzle.

It is another object of the present invention to provide the 3D printer as defined above, wherein said at least one curable polymer is Silicon.

It is another object of the present invention to provide the 3D printer as defined above, wherein said at least one curable polymer is characterized by viscosity lower that 10,000 cPs, curing time longer than 20 minutes and any combination thereof.

It is another object of the present invention to provide the 3D printer as defined above, wherein at least one of said at least one printing nozzles is adapted to extrude at least one additive manufacturing of a mold; further wherein said mold is a supporting structure for said 3D object.

It is another object of the present invention to provide the 3D printer as defined above, additionally comprising at least one heating element for heating said polymer in said mold.

It is another object of the present invention to provide the 3D printer as defined above, further comprising a first reservoir for storing a dissolvable material for additive manufacturing of said mold.

It is another object of the present invention to provide the 3D printer as defined above, further comprising at least one additional reservoir for storing liquid components of said heat curable polymer.

It is another object of the present invention to provide the 3D printer as defined above, wherein said heat curable polymer is selected from a group consisting of medical grade silicone, any long term implants and any combination thereof.

It is another object of the present invention to provide the 3D printer as defined above, wherein said heating element is positioned in proximity to, or in contact with, at least one of said at least one printing nozzle.

It is another object of the present invention to provide the 3D printer as defined above, wherein said printing head comprising at least one tray disposed below said at least one printing nozzle; wherein at least one of the following is held true: (a) said at least one tray is inclined to facilitate the collection of any non-printed curable polymer; (b) said at least one tray adapted to prevent any unwanted deposition of said at least one curable polymer on said at least one build plate; and any combination thereof.

It is another object of the present invention to provide the 3D printer as defined above, wherein said at least one tray comprising at least one opening, such that when said at least one printing nozzle is aligned with said at least one opening deposition of said at least one curable polymer on said at least one build plate is facilitated.

It is another object of the present invention to provide a method for vacuum sealed 3D printing, comprising steps of:
(a) providing at least one vacuum chamber defining at least one operational area, said at least one vacuum chamber sealingly sized and shaped to enclose:
   (i) at least one build plate; and,
   (ii) at least one printing head, comprising at least one printing nozzle for depositing at least one curable polymer on said at least one build plate for the formation of at least one 3D object;
(b) fluid tight communicating at least one vacuum pump with said at least one vacuum chamber;
(c) activating said vacuum pump to thereby apply vacuum within said vacuum chamber.

It is another object of the present invention to provide the method as defined above, wherein said at least one vacuum chamber comprising at least one door, hingedly connected to said at least one vacuum chamber.

It is another object of the present invention to provide the method as defined above, comprising at least one sealing member disposed along the perimeter of said at least one vacuum chamber.

It is another object of the present invention to provide the method as defined above, wherein, when said at least one door is closed, said at least one vacuum chamber is fluid tight sealed.

It is another object of the present invention to provide the method as defined above, wherein said at least one curable polymer is extruded out of said at least one printing nozzle.

It is another object of the present invention to provide the method as defined above, wherein said at least two curable polymers are extruded out of said at least one printing nozzle.

It is another object of the present invention to provide the method as defined above, wherein said at least two curable polymers are extruded at either a substantially constant ratio of amounts one relative to the other or at a varying ratio of amounts one relative to the other.

It is another object of the present invention to provide the method as defined above, wherein, when said at least one vacuum pump is inactive, no vacuum is applied within said at least one vacuum chamber; and, said at least one curable polymer is prevented from being extruded from said at least one printing nozzle to form said at least one 3D object.

It is another object of the present invention to provide the method as defined above, wherein, when said at least one vacuum pump is active, vacuum is applied within said at least one vacuum chamber; and, said at least one curable polymer is being extruded from said at least one printing nozzle.

It is another object of the present invention to provide the method as defined above, wherein said at least one curable polymer is contained within at least one container.

It is another object of the present invention to provide the method as defined above, wherein said at least one container comprises at least one valve adapted, when open, to facilitate extraction of said curable polymer therefrom; and when closed, to prevent extraction of said curable polymer therefrom.

It is another object of the present invention to provide the method as defined above, wherein when said at least one vacuum pump is active, vacuum is applied within said at least one vacuum chamber, said valve is open to facilitate entrance of air into said at least one container and extraction of said curable polymer therefrom is facilitated.

It is another object of the present invention to provide the method as defined above, wherein when said at least one vacuum pump is inactive, said valve is closed to prevent entrance of air into said at least one container and extraction of said curable polymer therefrom.

It is another object of the present invention to provide the method as defined above, wherein said applied vacuum facilitate in the removal of any trapped air bubbles in the extruded curable polymer.

It is another object of the present invention to provide the method as defined above, additionally comprising at least one vibration actuator arranged for providing a vibrating motion to said at least one build plate in a direction selected from a group consisting of x, y, z and any combination thereof.

It is another object of the present invention to provide the method as defined above, wherein said vibration actuator is an ultrasound transducer or any motoric means capable of applying vibrations.

It is another object of the present invention to provide the method as defined above, wherein said vibration facilitates in the removal of any trapped air bubbles in the extruded curable polymer.

It is another object of the present invention to provide the method as defined above, additionally comprising at least one vibration actuator arranged for providing a vibrating motion to said at least one printing head and/or said at least one printing nozzle, in a direction selected from a group consisting of x, y, z and any combination thereof.

It is another object of the present invention to provide the method as defined above, wherein said vibration actuator is an ultrasound transducer or any motoric means capable of applying vibrations

It is another object of the present invention to provide the method as defined above, wherein said vibration facilitates in the removal of any trapped air bubbles in the extruded curable polymer.

It is another object of the present invention to provide the method as defined above, wherein said at least one printing head and said at least one build plate are arranged to be translated relative to each other.

It is another object of the present invention to provide the method as defined above, wherein said at least one curable polymer is provided in the form selected from a group consisting of powders, liquids, gel and any combination thereof.

It is another object of the present invention to provide the method as defined above, wherein each printing nozzle is in communication with at least one feeding line.

It is another object of the present invention to provide the method as defined above, wherein each printing nozzle is in communication with a plurality of feeding lines.

It is another object of the present invention to provide the method as defined above, wherein each feeding line is adapted to provide different types of curable polymers to said printing nozzle.

It is another object of the present invention to provide the method as defined above, wherein each printing nozzle additionally comprising at least one mixer, adapted to mix different types of curable polymers before being extruded from said printing nozzle.

It is another object of the present invention to provide the method as defined above, wherein said at least one printing head is shaped as a revolving plate.

It is another object of the present invention to provide the method as defined above, wherein said printing head comprises at least one opening, such that once said at least one printing nozzle is aligned with said at least one opening, only said at least one curable polymer is extruded from said at least one printing nozzle.

It is another object of the present invention to provide the method as defined above, wherein said at least one printing head is in electrical communication with at least one stepper motor or servo motor, adapted to rotate said at least one printing head such that upon each move, one of said at least one of said printing nozzle is aligned with said opening to facilitate extruding of said at least one curable polymer.

It is another object of the present invention to provide the method as defined above, additionally comprising a processor, said processor controlling the position of said at least one printing head and said at least one printing nozzle over said operational area during the formation of said 3D object.

It is another object of the present invention to provide the method as defined above, wherein said processor is adapted to control at least one of said printing nozzles and the flow of said at least one curable polymer therethrough.

It is another object of the present invention to provide the method as defined above, wherein at least one selected from a group consisting of said at least one printing head, said at least one printing nozzle is a single used.

It is another object of the present invention to provide the method as defined above, wherein said at least one printing head comprising at least one cleaning element adapted to wipe clean said at least one printing nozzle.

It is another object of the present invention to provide the method as defined above, wherein said at least one curable polymer is Silicon.

It is another object of the present invention to provide the method as defined above, wherein said at least one curable polymer is characterized by viscosity lower that 10,000 cPs, curing time longer than 20 minutes and any combination thereof.

It is another object of the present invention to provide the method as defined above, wherein at least one of said at least one printing nozzles is adapted to extrude at least one additive manufacturing of a mold; further wherein said mold is a supporting structure for said 3D object.

It is another object of the present invention to provide the method as defined above, additionally comprising at least one heating element for heating said polymer in said mold.

It is another object of the present invention to provide the method as defined above, further comprising a first reservoir for storing a dissolvable material for additive manufacturing of said mold or skeleton support structure.

It is another object of the present invention to provide the method as defined above, further comprising at least one additional reservoir for storing liquid components of said heat curable polymer.

It is another object of the present invention to provide the method as defined above, wherein said heat curable polymer is selected from a group consisting of medical grade silicone, any long term implants and any combination thereof.

It is another object of the present invention to provide the method as defined above, wherein said heating element is positioned in proximity to, or in contact with, at least one of said at least one printing nozzle.

It is another object of the present invention to provide the method as defined above, wherein said printing head comprising at least one tray disposed below said at least one printing nozzle; wherein at least one of the following is held true: (a) said at least one tray is inclined to facilitate the collection of any non-printed curable polymer; (b) said at least one tray adapted to prevent any unwanted deposition of said at least one curable polymer on said at least one build plate; and any combination thereof.

It is another object of the present invention to provide the method as defined above, wherein said at least one tray comprising at least one opening, such that when said at least one printing nozzle is aligned with said at least one opening deposition of said at least one curable polymer on said at least one build plate is facilitated.

It is another object of the present invention to provide the method as defined above, additionally comprising step of using additive manufacturing to fabricate a portion of a mold.

It is another object of the present invention to provide the method as defined above, additionally comprising step of filling said portion of said mold with the heat curable polymer.

It is another object of the present invention to provide the method as defined above, additionally comprising step of heating at least a portion of said curable polymer.

It is another object of the present invention to provide the method as defined above, wherein said heating is performed at preselected location to provide mechanical support to said at least one 3D object, without the need to print dissolved supportive additives.

It is another object of the present invention to provide the method as defined above, wherein repeating said steps (a)-(c) results in fabricating said at least one 3D object.

It is another object of the present invention to provide the method as defined above, wherein said steps are performed simultaneously.

It is another object of the present invention to provide the method as defined above, wherein said at least one 3D object is a medical implant.

It is still an object of the present invention to provide the method as defined above, wherein said mold is manufactured from a dissolvable material.

It is lastly an of the present invention to provide the method as defined above, wherein said dissolvable material is selected from a group consisting of High Impact Polystyrene (HIPS) or Polyvinyl Alcohol (PVA) or any other dissolvable element.

According to one aspect of the present invention there is provided a method of fabricating an object from a heat curable polymer including (a) using additive manufacturing to fabricate a portion of a mold; (b) filling the portion of the mold with the heat curable polymer; (c) heating the polymer; and repeating steps (a)-(c) to fabricating the object.

According to embodiments of the present invention, said heating is performed at preselected location to provide mechanical support to said at least one 3D object, without the need to print dissolved supportive additives.

According to embodiments of the present invention steps (a) and (b) are performed simultaneously.

According to embodiments of the present invention the heat curable polymer is selected from a group consisting of medical grade silicone, any long term implants and any combination thereof.

According to embodiments of the present invention the object is a medical implant.

According to embodiments of the present invention steps (b) and (c) are performed simultaneously.

According to embodiments of the present invention step (c) is performed using a heated polymer-delivery nozzle.

According to embodiments of the present invention step (a) is performed using 3D printing.

According to embodiments of the present invention the mold is manufactured from a dissolvable material.

According to embodiments of the present invention the dissolvable material can be High Impact Polystyrene (HIPS) or Polyvinyl Alcohol (PVA) or any other dissolvable element.

According to embodiments of the present invention (a) and (b) are performed using side-by-side print nozzles.

According to another aspect of the present invention there is provided a system for fabricating an object from a heat curable polymer including: (a) a first nozzle configured for additive manufacturing of a mold (the mold could be e.g., a supporting structure for the printed 3D object); (b) a second nozzle for filling the mold with a heat curable polymer; and (c) a heating element for heating the polymer in the mold.

According to embodiments of the present invention, said heating is performed at preselected location to provide mechanical support to said at least one 3D object, without the need to print dissolved supportive additives.

According to embodiments of the present invention the first and the second nozzles are side-by-side print nozzles.

According to embodiments of the present invention the system further includes a first reservoir for storing a dissolvable material for additive manufacturing of the mold.

According to embodiments of the present invention the system further includes at least one additional reservoir for storing liquid components of the heat curable polymer.

According to embodiments of the present invention the heat curable polymer is selected from a group consisting of medical grade silicone, any long term implants and any combination thereof.

According to embodiments of the present invention the heating element is positioned in proximity to, or in contact with, the second nozzle.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

### BRIEF DESCRIPTION OF THE DRAWINGS

The invention is herein described, by way of example only, with reference to the accompanying drawings:

FIG. 1 is a flowchart outlining the fabrication process according to one embodiment of the present invention.

FIGS. 2A-B schematically illustrate a configuration of the present system which includes a dual nozzle printing head (FIG. 2A) and two independent printing heads (FIG. 2B).

FIG. 3 illustrates a silicone implant fabricated within a perishable mold.

FIG. 4 illustrates another embodiment of the present invention, in which a vibrating plate is utilized.

FIGS. 5-8 illustrate another embodiment of the present invention, in which a unique printing head/nozzle is utilized.

FIGS. 9a-9b illustrate another embodiment of the present invention, in which vacuum chamber is utilized.

### DETAILED DESCRIPTION OF THE INVENTION

The present invention provides a method which can be used to fabricate a customized implant from a medical grade heat-curable polymer. Specifically, the present invention can be used to fabricate a customized implant from implantable (and certified) medical grade silicone.

The principles and operation of the present invention may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

Silicone elastomer is formed by crosslinking silicone polymer chains via an addition reaction between the vinyl functional groups of a vinyl silicone polymer and the silicon hydride of a crosslinking agent containing SiH functions. The reaction requires the presence of a catalyst, usually an organometallic complex of platinum. Medical-grade silicone implants are fabricated from certified silicone component (raw materials) and a certified manufacturing process by heat curing the mixed components at the manufacturer's specified parameters of temperature and curing time.

In order to meet FDA/CE regulations the implant material must fully pass verification and validation testing including a bio-compatibility test and clinical testing as defined by the regulatory authorities (FDA/CE).

Raw silicone cannot be readily used in additive manufacturing approaches since the relatively lengthy cure time renders it unsuitable for rapid manufacturing.

Additive manufacturing of silicone components utilizes silicones that are chemically modified to enable rapid polymerization suitable for 3D printing.

Any modification of raw silicone renders a product manufactured thereby unsuitable for use as an implant since addition of components to the raw material redefines the silicone product as a new material that has to be recertified by regulatory authorities (including certification of the specific manufacturing process).

Thus, while modified silicones can be 3D printed, the resultant product does not meet regulatory guidelines and as such it cannot be used for fabrication of medical implants.

While reducing the present invention to practice, the present inventors have devised an approach for fabricating implants from a heat-curable medically approved for implant devices polymer such as silicone.

Thus, according to one aspect of the present invention there is provided a method of fabricating an object from a heat curable polymer.

The heat-curable polymer can be any single or multi-component polymer and is preferably approved for medical use or for use in the food and health industries. Examples of such polymers include silicone (NUSIL 48XX), polychloroprene (CR)/neoprene, ethylene propylene diene monomer (EPDM), fluoroelastomers (FKM)/Viton and acrylic rubber (ACM).

The object can be, for example, a medical implant used in orthopedic or reconstructive/aesthetic/corrective surgery. Such an implant can be, for example, breast implants, pectoral implants, facial and ear reconstruction implants, stents, indwelling catheters and the like.

The method of the present invention is carried by fabricating a portion of a mold using additive manufacturing and filling that portion with the heat curable polymer. The polymer is then heated to a solid or semi-solid state and the step of mold fabrication and polymer filling and curing is repeated one or more times until the object is completely fabricated. The object can then be freed from the mold by, for example, dissolving the mold material.

Such an approach, which is termed herein as “on-the-fly” molding enables:
(i) rapid and accurate fabrication of a variety of custom-made medical implants;
(ii) use of medical grade heat curable polymers such as silicone;
(iii) creation of structures having thin elements and texturing; and
(iv) creation of complex designs with nearly completely enclosed cavities.

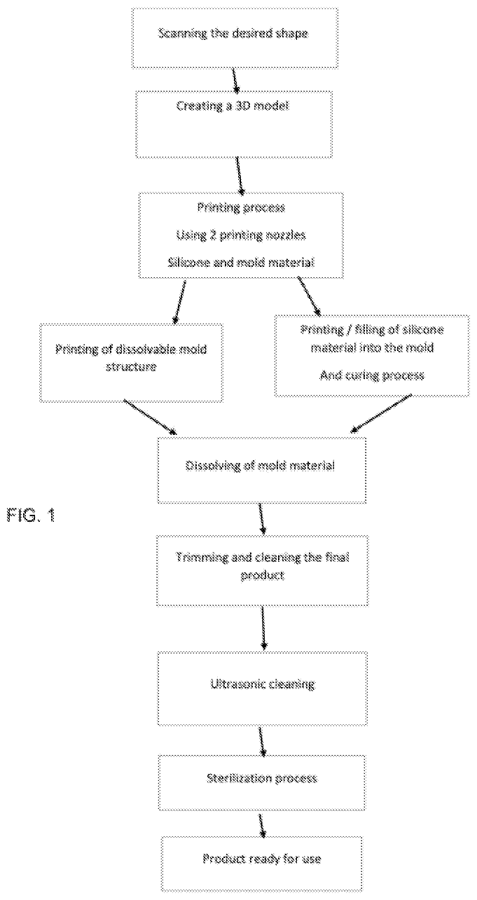

Referring now to the drawings, FIG. 1 is a flowchart outlining the steps of fabricating a medical implant via the present approach.

In order to fabricate a customized implant, the desired shape of the implant is first determined and modeled. For example, in cases where the implant augments or replaces an existing anatomical structure an imaging modality (e.g. X-ray, MRI) is first used to scan the anatomical structure and generate a 3D model using well known approaches.

The model can then be used to generate a model of the structure and needed mold using a CAD/CAM program and/or a specially designed and customized software for creating the printing file directly from pictures or any other scanning technology

The customized software computes and sets all the needed printing parameters, such as printing increments, sequence and mold design.

The mold parameters are then fed into a dual/two nozzle system capable of 3D printing the mold and injecting the heat-curable polymer (silicone) into the mold. Such a system is further described hereinbelow with reference to FIGS. 2A-B.

The system prints the mold and fills it in a stepwise or continuous fashion. The resolution of each step of the printing process can be determined by the structure of the printed part and the precision needed for that product. For simple objects that are largely volumetric (e.g., simple aesthetic implants) the process can be simultaneous with the mold being filled with the silicone as its being fabricated. For objects of more complex shapes, a stepwise mold building and filling process can be used. The mold can be fabricated with channels that facilitate mold filling with the polymer.

As is mentioned hereinabove, the polymer used by the present invention is heat curable. Curing can be effected during mold filling and/or following mold filling. In any case, curing can be effected using a heated nozzle or a heated environment. Curing can be partial during fabrication and completed in an oven following completion of the object. Curing is effected using the polymer recommended heat and time.

Once the implant is completely fabricated and cured it can be extracted from the mold (e.g., pulled out) or the mold can be dissolved (in the case of HIPS or PVA mold material). The final implant can then be trimmed to remove residual polymer elements created by the mold structure or imperfections and cleaned, ultrasonically treated (in detergent) and sterilized (gamma or autoclave) and packaged for use.

Since the present approach enables rapid and accurate fabrication of a medical implant it can be used in the hospital setting to fabricate an implant prior to or during surgery. An added advantage of the present approach is in the ability to produce several variations of an implant and to test each for fit within the timeframe of surgery.

FIGS. 2A-2B illustrate two configurations of a system 10 that can be used to carry out the fabrication process of the present invention.

System 10 can include a 3D printer having a 3D (X, Y, Z) stage, two printing heads each fitted with a nozzle. The printing head and nozzle for printing the mold can be a standard 3D printing head. The printing head and nozzle for dispensing the polymer can be configured for mixing the two components of the polymer (at the correct mixing ratio) and dispensing the mixed material though the printing nozzle. The apparatus may have a specially designed heating system including a heat extracting nozzle that can cure the printed polymer. System 10 can include an enclosure for creating an airless atmosphere in close proximity to the fabricated object to prevent unwanted air cavities (bubbles) inside the printed mold or injected object.

System 10 is configured for additive manufacturing using a first nozzle 12 and for injection of a heat curable polymer using nozzle 14 and heating element 16.

System 10 of FIG. 2A includes a single movable head with nozzles 12 and 14 mounted thereupon. System 10 of FIG. 2B includes two heads, each fitted with a nozzle. Thus, in the configuration of FIG. 2A, nozzles 12 and 14 move together in the X-axis (arrow) while in the configuration of FIG. 2B nozzles 12 and 14 are independently movable (along the X-axis, arrows).

Nozzle 12 is for printing the dissolvable mold material using FDM (fused deposition modeling) technology including a conveying disposing material system that pushes a wire material through the nozzle. Nozzle 14 is for printing the polymer material. It consists of a nozzle, a conveying disposing system that presses the mixed polymer material through the specially designed nozzle and setting the correct volume for the fabricated object. It also includes an automatic mixing system for mixing the two components of the polymer.

System 10 further includes reservoir 18 or material wire cassette for feeding the mold material to nozzle 12 and reservoirs 20 and 22 for feeding the liquid components of the heat-curable polymer to nozzle 14. In the case of silicone, the components are independently fed from reservoirs 20 and 22 and are mixed (e.g., using a mixer) prior to being pushed into nozzle 14. Once injected into a mold 24, a heat-curable polymer 26 is completely or partially cured using heating element 16.

It will be appreciated that a single reservoir can also be used for the heat-curable polymer. Such a reservoir can be filled with the premixed liquid. Heat element 16 can be integrated into nozzle 14 or positioned in close proximity (e.g., 1-10 mm) to nozzle 14 or from mold 24. As is described hereinabove, polymer 26 is injected into mold 24 during mold production (stepwise or simultaneous). In order to enable such functionality, system 10 is programmed to first print the mold from dissolvable material using nozzle 12. Once a first volumetric layer of the mold is fabricated, the polymer is printed/filled into that layer. These steps are repeated for each layer. A software controlling fabrication can automatically set the proper sequence of fabrication and can determine the printing increments based on accuracy and speed specified by final product specifications or user.

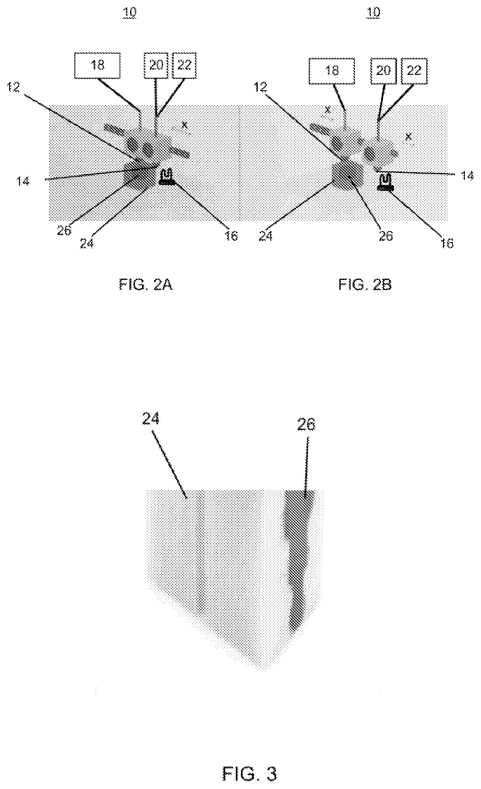

FIG. 3 illustrates mold 24 and fabricated implant 26 prior to implant extraction.

According to another embodiment of the present invention means adapted to remove bubble and imperfections caused during the printing process (in each layer being printed).

According to this embodiment, the 3D printer comprises a build/printing plate, upon which the resultant 3D printing is printed. Said printing plate is coupled in at least one location to ultrasound/RF transducer adapted to vibrate said build/printing plate in up to a 50 micrometres. The vibration frequency is in general larger than or equal to 5 Hz (and up to 300 Hz). Such movement will facilitate the removal of any trapped air bubbles (trapped in the printed model) out of each layer of printed polymer (e.g., Silicone) during the printing process.

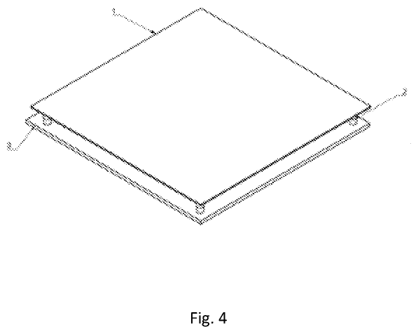

Reference is now made to FIG. 4 illustrating the build/printing plate 1, being placed on the base plate 3 being able to move in the Z direction. Said build/printing plate 1, having at, at one edge thereof, at least one ultrasound transducer 2 adapted to vibrate the build/printing 1 along the X, Y, Z axis and any combination thereof.

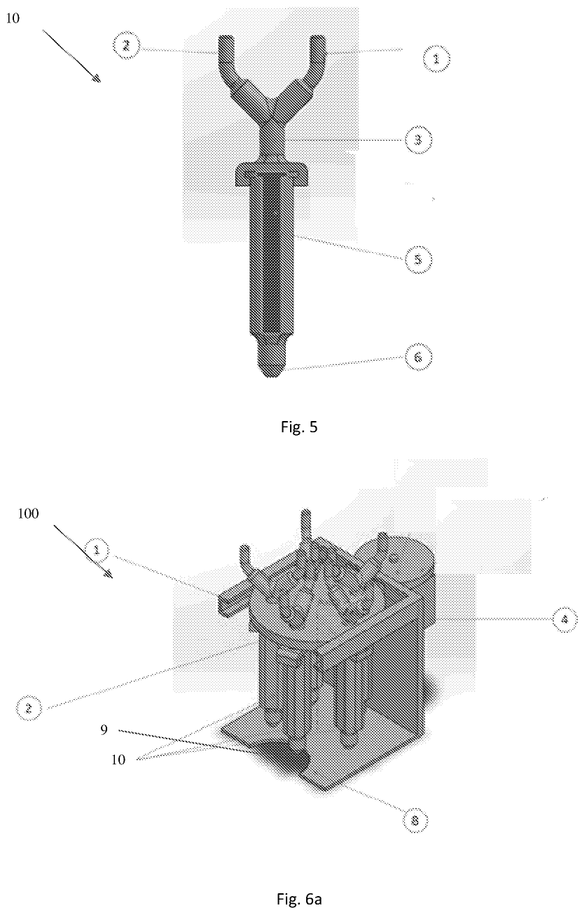

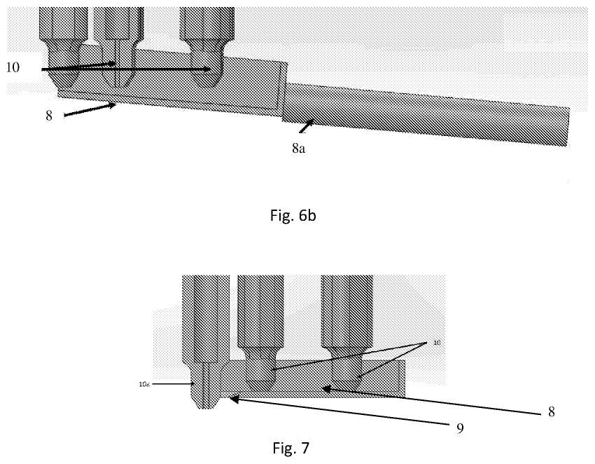

As will be seen in FIGS. 5-6, the printing head is movable along the X,Y directions (any combination thereof).

According to another embodiment of the present invention, the nozzle, out of which the polymer (e.g., the Silicon) is being extruded is coupled to at least one ultrasound transducer adapted to vibrate the printed polymer directly upon printing (it should be emphasized that any motoric means capable of applying vibrations is also within the scope of the present invention). In such an embodiment, the vibration of the ultrasound transducer could ‘use’ the liquid medium polymer (when a liquid phase polymer is used, e.g., Silicon) to translate the vibration to eventually eliminate any unwanted air bubbles.

Reference is now made to FIGS. 5-6 which illustrate another embodiment of the present invention. According to this embodiment, a unique printing nozzle 10 and printing head 100 are provided.

According to this embodiment, printing multiple types of materials (e.g., powders, liquids, gel and any combination thereof) are provided.

According to one embodiment, at least two feeding lines (each provides a different types of materials) are provided to the nozzle head. When said two lines meet, a mixer is provided to mix said materials and only thereafter the nozzle prints said mix.

Reference is now made to FIG. 5 illustrating such unique nozzle 10. As stated above, two feeding lines 1,2 are mixed at Y-intersection, 3. Said mixture flows (or pushed) within tube 5 towards the printing nozzle end 6.

According to one embodiment, the two printing materials, upon mixing, chemically react and hardens.

According to another embodiment, a motorize mixer (e.g., an impaler) is provided to mix the material.

According to one embodiment, the user can elect the amount of materials to be printed and the mixture ratio of said materials (in e.g., feeding lines 1,2) in nozzle 10. Such extrusion can be provided by e.g., extruder, piston that is disposed within the feeding lines and any other means known in the art.

According to one embodiment, the amount of materials to be printed and the mixture ratio of said materials (in e.g., feeding lines 1,2) in nozzle 10 is automatically elected, based on the desired 3D object to be printed.

According to another embodiment, a printing head comprising several such unique nozzles is provided.

Reference is now made to FIG. 6a which illustrates such a printing head. In this figure, the printing head 100 comprises 5 printing nozzles 10, each comprises 2 feeding lines. A total of 10 types of printing materials are enabled by the use of this printing head.

As disclosed above, the print head will have multiple nozzles and mixer to enable printing of multiple materials.

According to one embodiment, the head can be a revolving one. According to this embodiment, a special tray is provided for closing the printing nozzle and to prevent dripping between layers.

According to one embodiment, the print head is a single used head and is replaced after each print (both the mixer and nozzle).

Referring back to FIG. 6a, a rotating wheel is provided 2 (disposed on a dedicated rail 1) to which at least one printing nozzle 10 is provided. The rotating wheel 2 is in communication with at least one stepper motor or servo motor 4.

As seen in the figure, two feeding lines are provided to each printing nozzle.

Also illustrated in the figure, a tray 8 is also provided. As stated above, the tray is adapted to prevent any leakage of printing material from being unintentionally spilled from the printing head to the building plate.

According to one embodiment, at least one opening, 9, is provided in said tray to enable printing from at least one printing nozzle (that is aligned in proximity to said at least one opening 9).

According to another embodiment of the present invention, any excess material from the printing nozzle assembled on tray 8 will be collected either for reuse or for disposal. According to one embodiment, the tray comprises a slop to facilitate the collection of any excess curable polymer (e.g., silicon) that exits at least one printing nozzle.

According to another embodiment of the present invention, tray 8 is utilized to prevent any of the printing of the curable polymer whenever the same is not desired.

Reference is now being referred to FIG. 6b, illustrating such inclined tray 8. As seen in the figure, tray 8 has a slop that facilitate collection of any ‘spilled’ polymer (namely silicon) from the printing nozzle 10. According to one embodiment, the tray may comprise at least one tube, 8a into which all collected curable polymer flows.

According to another embodiment of the present invention, at least one of the printing nozzle is coupled to the rotating wheel 2 by means of a flexible arm (e.g., spring), such that when said nozzle is required for printing, the same is positioned above said opening 9 and moved to the building/printing plate for printing. Reference is now made to FIG. 7, illustrating such an embodiment. When printing nozzle 10a is needed for printing, nozzle is positioned in proximity to opening 9 and is positioned slightly below tray 8 so as to facilitate printing (extrusion of the curable polymer therefrom). It is noted that the remaining printing nozzles 10 are above the tray 8 and thus, printing therefrom is prevented.

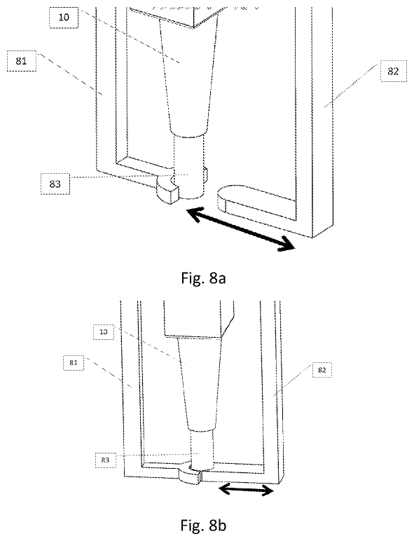

Reference is now made to FIGS. 8a-8b illustrating another embodiment of the present invention, according to which the printing nozzle's 10 distal end comprises an elastic/flexible tube 83 from which the curable polymer exits.

As seen in the Figs. two stoppers are provided. One stationary 81 and one a movable stopper 82. The movable stopper 82 can be move laterally with respect to the stationary stopper 81.

Thus, when there is a need to print the curable polymer, the movable stopper 82 is distant from the stationary stopper 81; and, when there is a need to prevent printing of the curable polymer, the movable stopper 82 is moved into contact with the stationary stopper 81, such that elastic/flexible tube 83 is squeezed between the two.

Such a design is highly advantageous as, unlike tray 8 being positioned below the distal tip of the printing nozzle 10 (and therefore, interfere with the printing), stoppers 81,82 are positioned in the same level as the distal-most tip of the printing nozzle 10 and therefore, does not interfere with the printing.

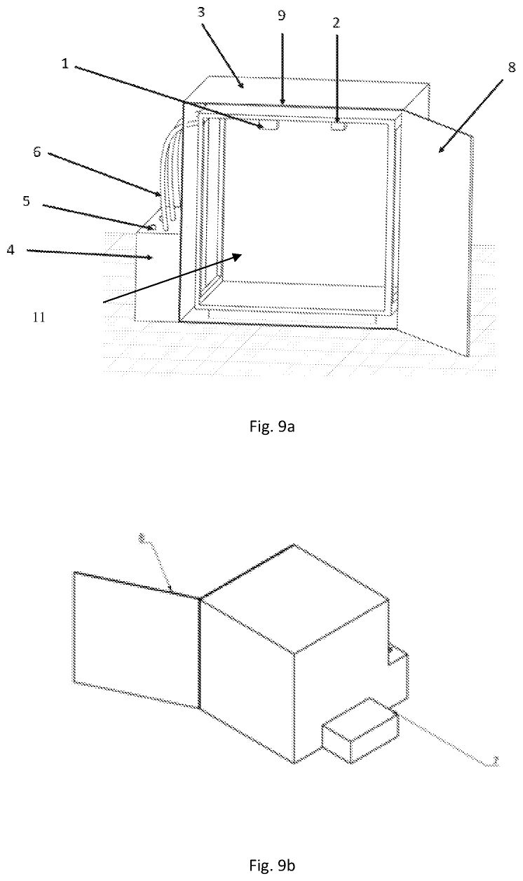

Reference is now made to FIGS. 9a-9b illustrating another embodiment of the present invention, according to which the entire printing is provided within a vacuum chamber. Such vacuum will (like the vibration disclosed above) facilitated removing unwanted air bubbles created during the printing.

According to one embodiment, the vacuum is activated at all time or just during specific intervals of time during printing.

According to another embodiment, the vacuum furnishes the extrusion of the printing material as redundant. Unlike the standard application of force to extrude (i.e., ‘push’) the printing materials into and within the printing nozzle, the application and removal of vacuum will provide the same result.

Reference is made again to FIGS. 9a-9b. As is illustrated, the polymer (namely, Silicone) printing nozzle 1, and the additives printing nozzle 2, as well as the printing/building late 11 are disposed within vacuum chamber 3.

The polymer (namely, Silicon) is provided to the nozzle printing nozzle 1 from container 4, through feeding pipe 6.

According to this embodiment, an air valve 5 is provided to enable the entrance of air into the container (when open) and prevent entrance of air into container 4 (when closed). As will be noted below, when said at least one vacuum pump is active, vacuum is applied within said at least one vacuum chamber 3 and said valve 5 is open (and thus, air enters the container 4); thus, extraction of said curable polymer therefrom is enabled (the air enters the container ‘pushes’ the curable polymer out and the vacuum ‘pulls’ the same to be extruded through the nozzle).

On the contrary, when said at least one vacuum pump is inactive and said valve 5 is closed to prevent extraction of said curable polymer therefrom (the air is prevented from entering the container 4).

Thus, while vacuum is constantly applied, valve 5 enables the extrusion of the polymer (when opened) and prevents the same (when closed).

It is noted that vacuum is provided within the vacuum chamber 3 by means of at least one vacuum pump 7. At least one door 8 and sealing (preferably rubber sealing) 9 are provided to ensure vacuum is provided.

According to another embodiment of the present invention, the printing process is amended. As, in printing liquid mediums (e.g., Silicon), hardening layers or providing support to enable the printing of complicated 3D model is required, it is within the scope of the present invention to discloses a 3D printing method where after printing a liquid medium layer, hardening specific location on said layers (using e.g., a heating element; either hot air or IR heating) to provide support to the next needed liquid medium layer. This step can be repeated as much as needed.

According to another embodiment, enabling printing of complicated 3D model is provided by hardening the entire last layer printed. Thus, in between layers, there is provided at least one harden layer.

According to another embodiment, ensuring that the required mold is full to the end, extra polymer (e.g., silicone) in the last layer to fill for any places that might be missing or compensating for material shrinkage.

According to another embodiment, a dedicated management software will be provided. Such management software will provide indication for any need for support within the 3D structure/between different silicone types/layers.

It is within the scope of the present invention, where the management software will also control at least one of the following:
1) sequence of the printing silicone and support/additive material(s)
2) managing the different types of support materials, dissolvable additives and silicone curing support
3) managing the filling of the mold at different predesignated printing steps
4) automatically determining the positioning of the printed part and the printing head relatively thereto.
5) Automatically setting the supports needed (either the amount of soluble additive or cured polymer) and combining that with the filling up steps of the created mold.

It is expected that during the life of this patent many relevant heat-curable medical grade polymers will be developed and the scope of the term heat-curable polymer is intended to include all such new technologies a priori.

As used herein the term “about” refers to ±10%.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. No feature described in the context of an embodiment is to be considered an essential feature of that embodiment, unless explicitly specified as such.

Although steps of methods according to some embodiments may be described in a specific sequence, methods of the disclosure may include some or all of the described steps carried out in a different order. The methods of the disclosure may include a few of the steps described or all of the steps described. No particular step in a disclosed method is to be considered an essential step of that method, unless explicitly specified as such.

1. A vacuum sealed 3D printer, comprising:
at least one vacuum chamber defining at least one operational area, said at least one vacuum chamber sealingly sized and shaped to enclose:
(i) at least one build plate, movable along at least one axis; and,
(ii) at least one printing head, movable along at least one axis, comprising at least one printing nozzle for depositing at least one curable polymer on said at least one build plate for the formation of at least one 3D object;
at least one vacuum pump, in fluid tight communication with said at least one vacuum chamber, such that when said vacuum pump is activated vacuum is applied within said vacuum chamber to remove air bubbles created during depositing said at least one curable polymer.

2. The 3D printer according to claim 1, wherein said at least two curable polymers are extruded out of said at least one printing nozzle.

3. The 3D printer according to claim 2, wherein said at least two curable polymers are extruded at either a substantially constant ratio of amounts one relative to the other or at a varying ratio of amounts one relative to the other.

4. The 3D printer according to claim 1, wherein, when said at least one vacuum pump is inactive, no vacuum is applied within said at least one vacuum chamber; and, said at least one curable polymer is prevented from being extruded from said at least one printing nozzle to form said at least one 3D object.

5. The 3D printer according to claim 1, wherein, when said at least one vacuum pump is active, vacuum is applied within said at least one vacuum chamber; and, said at least one curable polymer is being extruded from said at least one printing nozzle.

6. The 3D printer according to claim 1, wherein said at least one curable polymer is contained within at least one container.

7. The 3D printer according to claim 6, wherein said at least one container comprises at least one valve adapted, when open, to facilitate extraction of said curable polymer therefrom; and when closed, to prevent extraction of said curable polymer therefrom.

8. The 3D printer according to claim 6, wherein when said at least one vacuum pump is active, vacuum is applied within said at least one vacuum chamber, said valve is open to facilitate entrance of air into said at least one container and extraction of said curable polymer therefrom is facilitated.

9. The 3D printer according to claim 6, wherein when said at least one vacuum pump is inactive, said valve is closed to prevent entrance of air into said at least one container and extraction of said curable polymer therefrom.

10. The 3D printer according to claim 1, wherein said applied vacuum causes removal of any trapped air bubbles in the extruded curable polymer.

11. The 3D printer according to claim 1, additionally comprising at least one vibration actuator arranged for providing a vibrating motion to said at least one build plate, said at least one printing head and/or said at least one printing nozzle.

12. The 3D printer according to claim 11, wherein said vibration causes removal of any trapped air bubbles in the extruded curable polymer.

13. The 3D printer according to claim 1, wherein said at least one printing head is shaped as a revolving plate.

14. The 3D printer according to claims 1-43, wherein said printing head comprises at least one opening, such that once said at least one printing nozzle is aligned with said at least one opening, only said at least one curable polymer is extruded from said at least one printing nozzle.

15. The 3D printer according to claim 14, wherein said at least one printing head is in electrical communication with at least one stepper motor or servo motor, adapted to rotate said at least one printing head such that upon each move, one of said at least one of said printing nozzle is aligned with said opening to facilitate extruding of said at least one curable polymer.

16. The 3D printer according to claim 1, wherein said at least one printing head comprising at least one cleaning element adapted to wipe clean said at least one printing nozzle.

17. The 3D printer according to claim 1, wherein said at least one curable polymer is polymer is selected from a group consisting of medical grade silicone, any long term implants and any combination thereof.

18. A method for vacuum sealed 3D printing, comprising steps of:
(a) providing at least one vacuum chamber defining at least one operational area, said at least one vacuum chamber sealingly sized and shaped to enclose:
(i) at least one build plate; and,
(ii) at least one printing head, comprising at least one printing nozzle for depositing at least one curable polymer on said at least one build plate for the formation of at least one 3D object;
(b) fluid tight communicating at least one vacuum pump with said at least one vacuum chamber;
(c) activating said vacuum pump to thereby apply vacuum within said vacuum chamber; thereby removing air bubbles created during depositing said at least one curable polymer.
